(19) United States
(12) Patent Application Publication
(10) Pub. No.: US 2021/0293391 A1
(43) Pub. Date: Sep. 23, 2021

(54) LIGHTING MODULE FACILITATING COLOR MIXING

(71) Applicant: SIGNIFY HOLDING B.V., EINDHOVEN (NL)

(72) Inventors: Aldegonda Lucia WEIJERS, EINDHOVEN (NL); Peter Johannes Martinus BUKKEMS, EINDHOVEN (NL)

(21) Appl. No.: 17/053,786

(22) PCT Filed: May 27, 2019
(86) PCT No.: PCT/EP2019/063581

§ 371 Date: Nov. 8, 2020

(30) Foreign Application Priority Data
May 29, 2018 (EP) 18174830.2

(51) Int. Cl. F21K 9/62; F21V 3/02; F21V 19/00; F21V 23/00

(52) U.S. Cl. CPC F21K 9/62; F21V 3/02; F21Y 2103/10; F21V 23/003; F21V 19/001

(57) ABSTRACT

A lighting module (1) is disclosed, comprising at least one elongated carrier (2, 8) arranged to support a plurality of light-emitting elements (3) and configured to provide power to the plurality of light-emitting elements (3). The plurality of light-emitting elements (3) comprises at least a first set comprising a plurality of light-emitting elements and a second set comprising a plurality of light-emitting elements. The lighting module (1) comprises at least one optical element (4) coupled to the at least one elongated carrier (2, 8) and configured to receive light emitted from the first set of light-emitting elements when supplied with power and light emitted from the second set of light-emitting elements when supplied with power, respectively, mix the received light by means of diffusing and/or scattering the received light, and output the mixed light.

### TECHNICAL FIELD

The present invention relates to a lighting module and a lighting device comprising such a lighting module.

### BACKGROUND

So called filament lamps based on light-emitting diodes (LEDs) are becoming increasingly popular. In bulb lighting devices based on LEDs, commonly referred to as “retrofit lamps” since these LED lamps are often designed to have the appearance of a traditional incandescent light bulb and to be mounted in conventional sockets, etc., the light emitting filament wire is replaced with one or more LEDs, arranged in a configuration that mimics a light emitting filament wire, which may be referred to as a filament. Filament lamps are often used for ambiance creation in home lighting applications as well as in professional lighting applications, such as in bars, restaurants or hotels. Early versions of filament lamps were often only capable of emitting light of a single color. Presently, versions of filament lamps capable of emitting light of two colors (such as flame white and warm white colors) are available. Filament lamps are often used in so called open luminaires, in which the light sources in the luminaires are directly visible to the viewer. For multicolor filament lamps, it may however be difficult to achieve a lamp having the appearance of a traditional incandescent light bulb, since a diffuse outer bulb is generally needed to mix the colors of the lamp.

### SUMMARY

Color mixing in clear bulbs with filaments is often very difficult. There are hardly any means of doing so without affecting the visual appearance of the bulb. The mixing of color primaries (e.g., R, G, B) is particularly difficult since the individual color points are far apart in color space, and even minor color variations can be easily seen by the user. This is especially true when the color primaries are used to generate white light. The human eye is very sensitive to small color variations around the so called black body line (BBL), and even more so when the color variations cross the BBL.

In view of the above discussion, a concern of the present invention is to facilitate color mixing in a lighting module or lighting device such as of the filament lamp type, with no or less need for a diffuse outer bulb for achieving the color mixing.

To address at least one of this concern and other concerns, a lighting module in accordance with the independent claim is provided. Preferred embodiments are defined by the dependent claims.

According to a first aspect of the present invention, a lighting module is provided. The lighting module comprises at least one elongated carrier arranged to support a plurality of light-emitting elements (e.g., thereon and/or therein) and configured to provide power to the plurality of light-emitting elements. The plurality of light-emitting elements comprises at least a first set comprising a plurality of light-emitting elements and a second set comprising a plurality of light-emitting elements. The lighting module comprises at least one optical element coupled to the at least one elongated carrier and configured to receive light emitted from the first set of light-emitting elements when supplied with power and light emitted from the second set of light-emitting elements when supplied with power, respectively, mix the received light by means of diffusing and/or scattering the received light, and output the mixed light. The light-emitting elements of the first set and the second set and the at least one optical element are configured such that, when the light-emitting elements of the first set are emitting light and the light-emitting elements of the second set are not emitting light, light output from the at least one optical element is within a first wavelength range (e.g., of a first color, or white light), and such that, when the light-emitting elements of the second set are emitting light and the light-emitting elements of the first set are not emitting light, light output from the at least one optical element is within a second wavelength range (e.g., of a second color, or colored light), wherein the second wavelength range is different from the first wavelength range.

The at least one elongated carrier arranged to support a plurality of light-emitting elements may for example form a configuration which may mimic a light emitting filament wire, which may be referred to as a filament.

For example, the light-emitting elements of the first set and the second set and the at least one optical element may be configured such that, when the light-emitting elements of the first set are emitting light and the light-emitting elements of the second set are not emitting light, light output from the at least one optical element is white light (e.g., light ‘on the black body line’ (BBL)), and such that, when the light-emitting elements of the second set are emitting light and the light-emitting elements of the first set are not emitting light, light output from the at least one optical element is colored light (e.g., non-white light; light not ‘on the BBL’). The white light may for example have a wavelength within a wavelength range from (about) 440 nm to (about) 800 nm. Thus, the first wavelength range may for example be from (about) 440 nm to (about) 800 nm, and the second wavelength may be outside the first wavelength range, or substantially outside the first wavelength range, possibly with some overlap between the first wavelength range and the second wavelength range.

Thus, the light-emitting elements of the first set and the light-emitting elements of the second set may be used to generate different light emitted from the lighting module, such as, for example, white light and colored light, respectively. For example, the light-emitting elements of the first set may be used for generating light emitted from the lighting module that is ‘on the BBL’, and the light-emitting elements of the second set may be used for generating light emitted from the lighting module that is ‘off the BBL’. In that way, there may be little or even no need to mix colored light (e.g., RGB light) with white colors, which may simplify the color mixing of the light emitted by the light-emitting elements of the first set and the light-emitting elements of the second set, respectively, in the lighting module. As mentioned, mixing of color primaries (e.g., R, G, B) is particularly difficult since the individual color points are far apart in color space, and even minor color variations can be easily seen by the user, which is especially true when the color primaries are used to generate white light.

Thus, color mixing in the lighting module may be facilitated by way of the light-emitting elements of the first set and the second set and the at least one optical element being configured such that, when the light-emitting elements of the first set are emitting light and the light-emitting elements of the second set are not emitting light, light output from the at least one optical element is within a first wavelength range, and such that, when the light-emitting elements of the second set are emitting light and the light-emitting elements of the first set are not emitting light, light output from the at least one optical element is within a second wavelength range. The lighting module, by way of its at least one elongated carrier, may for example be of filament lamp type, and it may then only to small extent or even not at all require a diffuse outer bulb for achieving the color mixing, which is generally a requirement for achieving color mixing in previous multicolor filament lamps.

Color mixing in the lighting module may further be facilitated by way of appropriate arrangement or positioning of the light-emitting elements of the first set with respect to each other, and by way of appropriate positioning of the light-emitting elements of the second set with respect to each other. For example, each (or the) elongated carrier may have a longitudinal axis. The light-emitting elements of each of the first set of light-emitting elements and the second set of light-emitting elements may be arranged in at least one succession, or several successions (e.g., in at least one string, or several strings) on an elongated carrier, parallel to the longitudinal axis of the elongated carrier. For example, the light-emitting elements of the first set of light-emitting elements may be arranged in one succession, and the light-emitting elements of the second set of light-emitting elements may be arranged in another succession, which may be adjacent to the succession in which the light-emitting elements of the first set of light-emitting elements are arranged. According to another example, the light-emitting elements of the first set of light-emitting elements and the light-emitting elements of the second set of light-emitting elements could be arranged in one succession.

For example, in a succession (e.g., a row, a line, or a string) of light-emitting elements of for example the first set or second set of light-emitting elements, light-emitting elements capable of emitting light of different colors may be alternatingly arranged in the succession. For instance, the succession may include three light-emitting elements capable of emitting light in red, green, and blue light, respectively, in any order, possibly followed by one or more sets of three light-emitting elements capable of emitting light in red, green, and blue light, respectively. By placing light-emitting elements capable of emitting light of different colors in one succession (e.g., a row, a line, or a string), angular color variation in the light emitted by the lighting module may be reduced or even eliminated.

According to another example, two or more successions (e.g., rows, lines or strings) of light-emitting elements may be provided in for example the first set of light-emitting elements or the second set of light-emitting elements. The two or more successions of light-emitting elements may be positioned adjacent to each, and may be parallel or substantially parallel with each other. In each of the successions of light-emitting elements, the light-emitting elements thereof may be capable of emitting light of the same color. For example, there could be provided at least three successions (e.g., row, lines or strings) of light-emitting elements in for example the first set or second set of light-emitting elements, wherein in different ones of three successions of light-emitting elements, the light-emitting elements may be capable of emitting light of red, green, and blue color, respectively. That is, three successions of light-emitting elements may be provided wherein in a first succession, all of the light-emitting elements may be capable of emitting light of red color, and in a second succession, all of the light-emitting elements may be capable of emitting light of green color, and in a third succession, all of the light-emitting elements may be capable of emitting light of blue color. The three successions of light-emitting elements may be positioned adjacent to each, and may be parallel or substantially parallel with each other. The pitch or distance between light-emitting elements in the respective ones of the successions of light-emitting elements may be the same, or substantially the same. In order for the light-emitting elements in the three successions of light-emitting elements (in the first set of light-emitting elements or in the second set of light-emitting elements) to be positioned as close as possible to each other, the successions of light-emitting elements may be staggered with respect to each other. By positioning the light-emitting elements in the three successions of light-emitting elements as close as possible to each other, color mixing in the light emitted by the three successions of light-emitting elements (e.g., in the first set of light-emitting elements or the second set of light-emitting elements) may be facilitated. Possibly, for example in case the light-emitting elements comprise LEDs, the distance between adjacent light-emitting elements (e.g., in the first set of light-emitting elements or the second set of light-emitting elements) may be between (about) 0.1 mm and (about) 0.5 mm, or between (about) 0.1 mm and (about) 0.25 mm.

The at least one optical element may for example be arranged (directly or indirectly, via one or more intermediate optical components) on the plurality of light-emitting elements, or at least on the first set of light-emitting elements and the second set of light-emitting elements, respectively. Possibly, the lighting module may comprise a plurality of optical elements, comprising at least a first optical element and a second optical element. The first optical element may be configured to receive light emitted from the first set of light-emitting elements when supplied with power, mix the received light by means of diffusing and/or scattering the received light, and output the mixed light. The second optical element may be configured to receive light emitted from the second set of light-emitting elements when supplied with power, mix the received light by means of diffusing and/or scattering the received light, and output the mixed light.

The at least one optical element, or each of the plurality of optical elements, may for example comprise at least one of: light scattering elements, luminescent material, or material configured to diffuse and/or scatter light incident or impinging thereon.

For example, the light-scattering elements may comprise light-scattering particles embedded or integrated in a light-transmissive substrate. In alternative or in addition, the light-scattering elements, and/or the material configured to diffuse and/or scatter light incident or impinging thereon, may comprise a layer or coating of material such as Al₂O₃, BaSO₄ and/or TiO₂, and/or a surface of the at least one optical element, or each of the plurality of optical elements, may be made diffusing, e.g. so as to exhibit a rough structure. The light-scattering elements may consist of optical surface structures, intended to scatter the light and/or to direct the light in any preferred directions.

The at least one optical element, or each of the plurality of optical elements, may for example comprise a plurality of light diffusing layers, which may be optically interconnected with each other. The plurality of light diffusing layers may for example be arranged on top of each other (e.g, stacked). Each of the plurality of light diffusing layers may be configured to diffuse and/or scatter light incident or impinging thereon. Each or any of the light diffusing layers may for example be made of silicon or another similar material. Each or any of the light diffusing layers may be configured to diffuse and/or scatter light incident or impinging thereon to different extent or degree. Thus, by providing of such a plurality of light diffusing layers, tailoring of the capacity or capability to diffuse and/or scatter light of the at least one optical element, or each of the plurality of optical elements, may be facilitated or allowed.

The at least one optical element, or each of the plurality of optical elements, may for example comprise one or more light-transmissive layers, and one of more light diffusing and/or scattering layers. Each or any one of the light diffusing and/or scattering layers may be configured to diffuse and/or scatter light incident or impinging thereon. Each or any of the light diffusing and/or scattering layers may for example be made of silicon or another similar material. Each or any of the light-transmissive layers may comprise in principle any appropriate light-transmissive material, and may be configured so as to not or only to a small extent diffuse and/or scatter light. The one or more light-transmissive layers and the one of more light diffusing and/or scattering layers may be optically interconnected with each other, and may for example be arranged on top of each other (e.g., stacked), in any order. According to one or more embodiments of the present invention, the one or more light-transmissive layers may be configured so as to form a light mixing chamber for the received light capable of mixing the received light, wherein the one of more light diffusing and/or scattering layers are configured to further mix the received light that has been mixed in the light mixing chamber by means of diffusing and/or scattering the light from the light mixing chamber. By way of such a light mixing chamber, color mixing in the lighting module may be further facilitated. To that end, the one or more light-transmissive layers may be optically interconnected with each other, for example by being arranged on top of each other (e.g., stacked), the one of more light diffusing and/or scattering layers may be optically interconnected with each other, for example by being arranged on top of each other (e.g., stacked), and the optically interconnected light-transmissive layer(s) may then be optically interconnected with the optically interconnected light diffusing and/or scattering layer(s), e.g., so as to form an arrangement or stack of light-transmissive layer(s) followed by light diffusing and/or scattering layer(s).

The at least one optical element, or each of the plurality of optical elements, may for example comprise an encapsulant which may be at least partially enclosing the plurality of light-emitting elements, or at least the first set of light-emitting elements and the second set of light-emitting elements, respectively. There may be several encapsulants. Each or any of the encapsulants may for example be made of silicon or another similar material. Possibly, there may be provided a first encapsulant, which may be at least partially enclosing the first set of light-emitting elements, and a second encapsulant, which may be at least partially enclosing the second set of light-emitting elements.

The at least one elongated carrier may for example comprise at least one printed circuit board (PCB), such as, for example, at least one flexible PCB and/or a multilayer PCB. In alternative, or in addition, the at least one elongated carrier may for example comprise at least one flexible foil (e.g., ‘flexfoil’). Such a PCB may be configured to support the plurality of light-emitting elements, or at least on the first set of light-emitting elements and the second set of light-emitting elements, respectively, and provide power thereto (e.g., by way of one or more electrically conductive tracks or traces, as known in the art).

Each or any one of the plurality of light-emitting elements may for example include or be constituted by a solid state light emitter. Examples of solid state light emitters include light-emitting diodes (LEDs) and organic LEDs (OLEDs). Solid state light emitters are relatively cost efficient light sources since they in general are relatively inexpensive and have a relatively high optical efficiency and a relatively long lifetime. However, in the context of the present application, the term “light-emitting element” should be understood to mean substantially any device or element that is capable of emitting radiation in any region or combination of regions of the electromagnetic spectrum, for example the visible region, the infrared region, and/or the ultraviolet region, when activated e.g. by applying a potential difference across it or passing a current through it. Therefore, a light-emitting element can have monochromatic, quasi-monochromatic, polychromatic or broadband spectral emission characteristics. Examples of light-emitting elements include semiconductor, organic, or polymer/polymeric LEDs, violet LEDs, blue LEDs, optically pumped phosphor coated LEDs, optically pumped nano-crystal LEDs or any other similar devices as would be readily understood by a person skilled in the art. Furthermore, the term light-emitting element can, according to one or more embodiments of the present invention, mean a combination of the specific light-emitting element(s) which emit the radiation in combination with a housing or package within which the specific light-emitting element(s) is positioned or arranged. For example, the term light-emitting element or light-emitting module can encompass a bare LED die arranged in a housing, which may be referred to as a LED package. According to another example, the light-emitting element may comprise a Chip Scale Package (CSP) LED, which may comprise a LED die directly attached to a substrate such as a PCB, and not via a sub-mount.

The at least one elongated carrier may for example comprise at least one (light) strip, such as, for example, at least one LED strip.

The lighting module may for example comprise at least two elongated carriers, which may comprise at least a first elongated carrier and a second elongated carrier. The light-emitting elements of the first set and the light-emitting elements of the second set may be supported on different carriers. For example, the light-emitting elements of the first set may be supported on the first elongated carrier, and the light-emitting elements of the second set may be supported on the second elongated carrier.

Each of the first elongated carrier and the second elongated carrier may have a longitudinal axis. The light-emitting elements of the first set of light-emitting elements may be arranged in at least one succession (e.g., in a line or string) on the first elongated carrier parallel to the longitudinal axis of the first elongated carrier. The light-emitting elements of the second set of light-emitting elements may be arranged in at least one succession (e.g., in a line or string) on the second elongated carrier parallel to the longitudinal axis of the second elongated carrier.

All of the light-emitting elements of the first set of light-emitting elements arranged in the at least one succession on the first elongated carrier may be configured to emit light, when supplied with power, within the same wavelength range. In alternative, at least one (or some) of the light-emitting elements of the first set of light-emitting elements arranged in the at least one succession on the first elongated carrier may be configured to emit light, when supplied with power, within a different wavelength range than at least one other light-emitting element of the first set of light-emitting elements arranged in the at least one succession on the first elongated carrier.

In alternative, or in addition, all of the light-emitting elements of the second set of light-emitting elements arranged in the at least one succession on the second elongated carrier may be configured to emit light, when supplied with power, within the same wavelength range, or at least one (or some) of the light-emitting elements of the second set of light-emitting elements arranged in the at least one succession on the second elongated carrier may be configured to emit light, when supplied with power, within a different wavelength range than at least one other light-emitting element of the second set of light-emitting elements arranged in the at least one succession on the second elongated carrier.

The light-emitting elements of the first set of light-emitting elements may be arranged in a plurality of successions (e.g., in a plurality of lines or strings) on the first elongated carrier. Each of the plurality of successions may be parallel to the longitudinal axis of the first elongated carrier. The light-emitting elements of the second set of light-emitting elements may be arranged in a plurality of successions (e.g., in a plurality of lines or strings) on the second elongated carrier. Each of the plurality of successions may be parallel to the longitudinal axis of the second elongated carrier.

All of the light-emitting elements in the respective ones of the plurality of successions of light-emitting elements on the first elongated carrier and/or the second elongated carrier may be configured to emit light, when supplied with power, within a same wavelength range. The light-emitting elements in different ones of the plurality of successions of light-emitting elements on the first elongated carrier and/or the second elongated carrier may be configured to emit light, when supplied with power, within different wavelength ranges.

The light-emitting elements of the first set of light-emitting elements may for example be arranged in at least three successions on the first elongated carrier. Each of the at least three successions may be parallel to the longitudinal axis of the first elongated carrier. In alternative, or in addition, the light-emitting elements of the second set of light-emitting elements may be arranged in at least three successions on the second elongated carrier, wherein each of the at least three successions may be parallel to the longitudinal axis of the second elongated carrier.

The light-emitting elements in different ones of the at least three successions of light-emitting elements on the first elongated carrier or the second elongated carrier may for example be configured to emit red, green, and blue light, respectively, when supplied with power.

The plurality of successions of light-emitting elements on the first elongated carrier may be staggered, or not staggered, with respect to each other. In alternative, or in addition, the plurality of successions of light-emitting elements on the second elongated carrier may be staggered, or not staggered, with respect to each other.

The pitch or distance between light-emitting elements in one of the plurality of successions of light-emitting elements on the first elongated carrier may be different from or the same as the pitch or distance between light-emitting elements in another one (e.g., an adjacent one) of the plurality of successions of light-emitting elements on the first elongated carrier. Similarly, the pitch or distance between light-emitting elements in one of the plurality of successions of light-emitting elements on the second elongated carrier may be different from or the same as the pitch or distance between light-emitting elements in another one (e.g., an adjacent one) of the plurality of successions of light-emitting elements on the second elongated carrier.

In the context of the present application, by a succession of light-emitting elements being parallel to the longitudinal axis of carrier, or an elongated carrier, it is not necessarily meant that the succession of light-emitting elements is exactly parallel to the longitudinal axis, but a small angle (e.g., one or a few degrees) between an axis defining the succession of light-emitting elements and the longitudinal axis may be permitted.

As mentioned, the lighting module may for example comprise at least two elongated carriers. The lighting module may comprise a coupling carrier, which may be configured to couple to and support each of the at least two elongated carriers.

The coupling carrier may be flexible, and may in that case for example comprise a flexible PCB or a flexfoil or the like, or it may be rigid, and may in that case for example comprise a PCB or another type of rigid support structure. Each or any of the at least two elongated carriers may be for example be flexible, and may in that case for example comprise a flexible PCB or a flexfoil or the like, or it may be rigid.

The at least one elongated carrier may be arranged to support the plurality of light-emitting elements at or on a first side of the at least one elongated carrier. At least one electrical conductor for providing power to the plurality of light-emitting elements may be arranged at a second side of the at least one elongated carrier. By arranging the at least one electrical conductor for providing power to the plurality of light-emitting elements at a second side of the at least one elongated carrier, different from the first side of the at least one elongated carrier, there may be less or no need for electrical conductor(s) at or on the first side of the at least one elongated carrier, which may facilitate the color mixing in the lighting module. This is due to that any electrical conductor(s) at or on the first side of the at least one elongated carrier, at which first side the plurality of light-emitting elements also are, may negatively affect the color mixing capability of the lighting module. Further, by arranging the at least one electrical conductor for providing power to the plurality of light-emitting elements at a second side of the at least one elongated carrier, different from the first side of the at least one elongated carrier, the lighting module may have a relatively small form factor. However, electrical conductor(s) could possibly be provided at or on the first side of the at least one elongated carrier.

The at least one electrical conductor arranged at the second side of the at least one elongated carrier may be connected to the at least one, some, or all of the plurality of light-emitting elements by way of at least one electrical connection, or a plurality of electrical connections, between the first side of the at least one elongated carrier and the second side of the at least one elongated carrier. The at least one electrical connection may for example comprise one or more vies.

As mentioned, the light-emitting elements of the first set of light-emitting elements and/or the second set of light-emitting elements may be arranged in at least one succession (e.g., in a line or string), or in a plurality of successions (e.g., in a plurality of lines or strings). The light-emitting elements in any succession may for example be connected in series. Different successions of light-emitting elements in the first set of light-emitting elements and/or in the second set of light-emitting elements may be connected in series, or in parallel.

Different ones of the light-emitting elements in any succession (e.g., a line or string) may be connected to the at least one electrical conductor arranged at the second side of the at least one elongated carrier by way of respective electrical connections between the first side of the at least one elongated carrier and the second side of the at least one elongated carrier. The electrical connection may for example comprise vias. The light-emitting elements may, as mentioned, for example comprise LEDs. By connecting different ones of the light-emitting elements in any succession to the at least one electrical conductor arranged at the second side of the at least one elongated carrier by way of respective electrical connections between the first side of the at least one elongated carrier and the second side of the at least one elongated carrier, controlling of forward voltage of the LEDs may be facilitated or allowed.

The at least one elongated carrier may for example comprise a multilayer substrate, such as, for example, a multilayer printed circuit board (PCB) or the like, and the at least one electrical conductor for providing power to the plurality of light-emitting elements arranged at a second side of the at least one elongated carrier may for example include one or more electrically conductive tracks or traces on or in a layer of the multilayer substrate at the second side.

The first side and the second side of the at least one elongated carrier may be opposite sides of the at least one elongated carrier.

A lighting module according to the first aspect may be suitable for use for example in lighting devices having a light-transmissive envelope such as a light bulb at least in part enclosing the lighting module, with the lighting module being arranged within the light bulb or light-transmissive envelope. The light-transmissive envelope may for example may be made of glass or ceramic.

According to a second aspect, a lighting device is provided. The lighting device may for example comprise a lamp, a light engine and/or a luminaire. The lighting device comprises a lighting module according to the first aspect, or possibly several lighting modules according to the first aspect.

The lighting device may comprise a light-transmissive envelope which at least in part encloses the lighting module. The light-transmissive envelope may at least in part define a fluidly sealed and enclosed space within which the lighting module is arranged, and which space may include or be filled with air or a thermally conductive fluid, for example a gas including helium and/or hydrogen. The lighting device may comprise a base for connection to a lamp socket. The base may include or be constituted by any suitable type of connector, for example an Edison screw base, a bayonet fitting, or another type of connection. The lighting device may for example be included in or constitute a LED bulb or retrofit lamp which is connectable to a lamp or luminaire socket by way of some appropriate connector, for example an Edison screw base, a bayonet fitting, or another type of connection suitable for the lamp or luminaire known in the art.

In alternative, or in addition, a lighting module according to the first aspect may for example be used in a high power linear light source comprising one or more heat transferring devices such as, for example, one or more heat pipes. In such a high power linear light source, the lighting module, or the at least one elongated carrier thereof, may be connected or coupled to at least one heat transferring device of the high power linear light source. Thus, the lighting device may for example comprise a (high power) linear light source comprising one or more heat transferring devices such as, for example, one or more heat pipes, wherein the lighting module may be connected or coupled to at least one heat transferring device of the linear light source.

In alternative, or in addition, a lighting module according to the first aspect may for example be used in a so called panel light, wherein the lighting module may be arranged inside the panel light (e.g., within a cavity of the panel light), whereby a panel light capable of emitting color tunable light may be achieved. Thus, the lighting device may for example comprise a panel light, wherein the lighting module lighting module may be arranged inside the panel light (e.g., within a cavity of the panel light).

The lighting module and/or the lighting device may include circuitry capable of converting electricity from a power supply to electricity suitable to operate or drive the light-emitting elements. The circuitry may be capable of at least converting between Alternating Current and Direct Current and converting voltage into a suitable voltage for operating or driving the light-emitting elements.

The lighting device may comprise a control unit connected to the at least one elongated carrier and configured to control supply of power to the plurality of light-emitting elements. Supply of power to the plurality of light-emitting elements may possibly be able to be controlled individually or group-wise by the control unit. The control unit may be configured to control supply of power selectively to the first set of light-emitting elements or to the second set of light-emitting elements, but not to both the first set of light-emitting elements and the second set of light-emitting elements at the same time.

Another way to describe this configuration of the control unit is that the control unit may be configured to control supply of power to the plurality of light-emitting elements such that none of the light-emitting elements of the second set is emitting light while at least one of the light-emitting elements of the first set is emitting light, and such that none of the light-emitting elements of the first set is emitting light while at least one of the light-emitting elements of the second set is emitting light.

Possibly, the control unit may be comprised in the at least one lighting module. In case of there being provided several lighting modules, the control unit may be comprised in one of the lighting modules, and with the lighting module comprising the control unit possibly being coupled or connected to the other lighting module(s). Possibly, there could be several control units, with each control unit possibly being comprised in respective ones of different lighting modules.

The control unit may for example comprise driver circuitry for controlling supply of power to the plurality of light-emitting elements and/or for controlling operation of the plurality of light-emitting elements. The driver circuitry may for example comprise LED driver circuitry configured to drive (or control) one or more LEDs which may be comprised in or constitute the plurality of light-emitting elements.

The control unit may be configured to control operation of each or any of the light-emitting elements for example by way of transmitting at least one control signal or control message or the like to the light-emitting element(s).

Further objects and advantages of the present invention are described in the following by means of exemplifying embodiments. It is noted that the present invention relates to all possible combinations of features recited in the claims. Further features of, and advantages with, the present invention will become apparent when studying the appended claims and the description herein. Those skilled in the art realize that different features of the present invention can be combined to create embodiments other than those described herein.

### BRIEF DESCRIPTION OF THE DRAWINGS

Exemplifying embodiments of the invention will be described below with reference to the accompanying drawings.

FIG. 1 is a schematic exploded view of parts of a lighting module in accordance with an embodiment of the present invention.

FIG. 2 is a perspective view of the parts of the lighting module illustrated in FIG. 1, in an assembled state.

FIGS. 3 and 4 are views of lighting devices according to embodiments of the present invention.

All the figures are schematic, not necessarily to scale, and generally only show parts which are necessary in order to elucidate embodiments of the present invention, wherein other parts may be omitted or merely suggested.

### DETAILED DESCRIPTION

The present invention will now be described hereinafter with reference to the accompanying drawings, in which exemplifying embodiments of the present invention are shown. The present invention may, however, be embodied in many different forms and should not be construed as limited to the embodiments of the present invention set forth herein; rather, these embodiments of the present invention are provided by way of example so that this disclosure will convey the scope of the invention to those skilled in the art. In the drawings, identical reference numerals denote the same or similar components having a same or similar function, unless specifically stated otherwise.

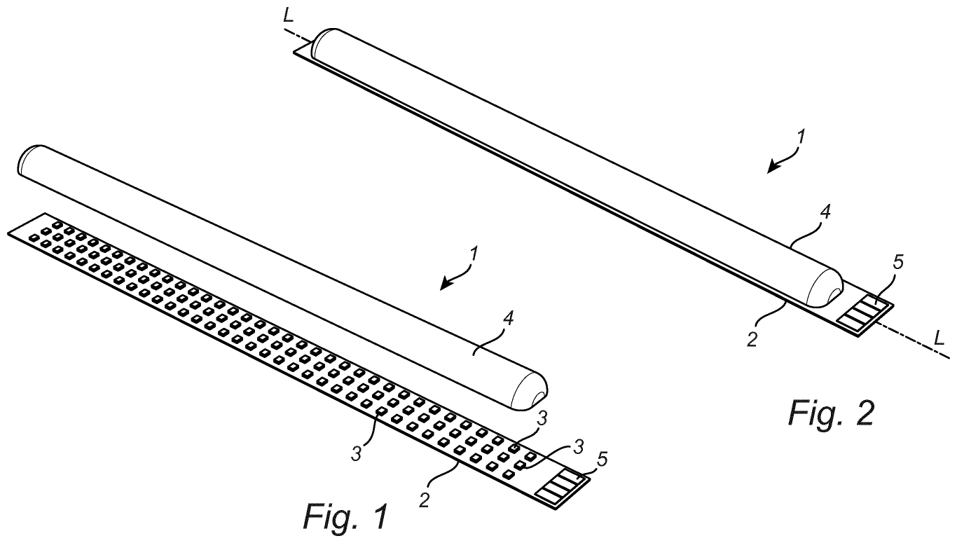

FIG. 1 is a schematic exploded view of parts of a lighting module 1 in accordance with an embodiment of the present invention. FIG. 2 is a perspective view of the parts of the lighting module 1 illustrated in FIG. 1, in an assembled state.

In accordance with the embodiment of the present invention illustrated in FIGS. 1 and 2, the lighting module 1 comprises at least two elongated carriers, comprising at least a first elongated carrier and a second elongated carrier, wherein the first elongated carrier 2 is illustrated in FIGS. 1 and 2. The first elongated carrier 2 is arranged to support a plurality of light-emitting elements 3 (only some of the light-emitting elements are indicated by reference numerals 3 in FIG. 1) and configured to provide power to the plurality of light-emitting elements 3. The second elongated carrier (not shown in FIGS. 1 and 2) is similar to the first elongated carrier 2. Just as the first elongated carrier 2, the second elongated carrier is arranged to support a plurality of light-emitting elements and configured to provide power to the plurality of light-emitting elements. A first set of light-emitting elements are supported on the first elongated carrier 2, and a second set of light-emitting elements are supported on the second elongated carrier.

In accordance with the embodiment of the present invention illustrated in FIGS. 1 and 2, the lighting module 1 comprises at least two optical elements, comprising at least a first optical element and a second optical element, wherein the first optical element 4 is illustrated in FIGS. 1 and 2. The first optical element 4 is coupled to the first elongated carrier 2. The first optical element 4 is configured to receive light emitted from the first set of light-emitting elements of the first elongated carrier 2 when supplied with power, mix the received light by means of diffusing and/or scattering the received light, and output the mixed light.

The second optical element (not shown in FIG. 1 or 2) may be similar to the first optical element 4. The second optical element is coupled to the second elongated carrier. The second optical element is configured to receive light emitted from the second set of light-emitting elements of the second elongated carrier when supplied with power, mix the received light by means of diffusing and/or scattering the received light, and output the mixed light.

In accordance with the embodiment of the present invention illustrated in FIGS. 1 and 2, the first optical element 4 is arranged (directly or indirectly, via one or more intermediate optical components) on the side of the first elongated carrier 2 on which the first set of light-emitting elements of the first elongated carrier 2 are arranged, and possibly on the first set of light-emitting elements of the first elongated carrier 2. For example, the first optical element 4 may for example comprise at least one of: light scattering elements, luminescent material, or material configured to diffuse and/or scatter light incident or impinging thereon. For example, the light-scattering elements may comprise light-scattering particles embedded or integrated in a light-transmissive substrate. In alternative or in addition, the light-scattering elements, and/or the material configured to diffuse and/or scatter light incident or impinging thereon, may comprise a layer or coating of material such as Al₂O₃, BaSO₄ and/or TiO₂, and/or a surface of the first optical element 4 may be made diffusing, e.g. so as to exhibit a rough structure. The light-scattering elements may consist of optical surface structures, intended to scatter the light and/or to direct the light in any preferred directions.

The second optical element may be arranged in relation to the second elongated carrier and the second set of light-emitting elements of the second elongated carrier similarly or in the same way as the first optical element 4 arranged in relation to the first elongated carrier 4 and the first set of light-emitting elements of the first elongated carrier 4, for example such as described in the foregoing. Further, the second optical element may be configured similarly or in the same way as the first optical element 4, for example such as described in the foregoing.

Each or any of the first elongated carrier 2 and the second elongated carrier may for example comprise at least one printed circuit board (PCB), such as, for example, at least one flexible PCB and/or a multilayer PCB. In alternative, or in addition, each or any of the first elongated carrier 2 and the second elongated carrier may for example comprise at least one flexible foil (e.g., ‘flexfoil’).

As illustrated in FIG. 1, the first elongated carrier 2 may comprise one or more electrical contacts 5 for connecting the first elongated carrier 2 to at least one of one or more other components, such as, for example, a power source, or a control unit and/or driver circuitry. The second elongated carrier may also comprise such one or more electrical contacts.

Each or any one of the plurality of light-emitting elements supported on the first elongated carrier 2 and/or the second elongated carrier, or each or any one of light-emitting elements of the first set of light-emitting elements of the first elongated carrier 2 and/or the second set of light-emitting elements of the second elongated carrier may for example include or be constituted by one or more light-emitting diodes (LEDs).

The light-emitting elements of the first set and the second set and the first optical element 4 and the second optical element may be configured such that, when the light-emitting elements of the first set are emitting light and the light-emitting elements of the second set are not emitting light, light output from the first optical element 4 is within a first wavelength range, and such that, when the light-emitting elements of the second set are emitting light and the light-emitting elements of the first set are not emitting light, light output from the second optical element is within a second wavelength range. The second wavelength range may be different from the first wavelength range. Thus, the light-emitting elements of the first set and the light-emitting elements of the second set may be used to generate different light emitted from the lighting module, such as, for example, white light and colored light, respectively.

As described in the foregoing, the first set of light-emitting elements are supported on the first elongated carrier 2, and the second set of light-emitting elements are supported on the second elongated carrier. However, this is not required. For example, in alternative, both the first set of light-emitting elements and the second set of light-emitting elements could be supported on a common (elongated) carrier. A common optical element could be coupled to the common carrier, wherein the common optical element may be configured to receive light emitted from the first set of light-emitting elements when supplied with power and light emitted from the second set of light-emitting elements when supplied with power, respectively, mix the received light by means of diffusing and/or scattering the received light, and output the mixed light. The light-emitting elements of the first set and the second set and the common optical element could be configured such that, when the light-emitting elements of the first set are emitting light and the light-emitting elements of the second set are not emitting light, light output from the common optical element is within a first wavelength range, and such that, when the light-emitting elements of the second set are emitting light and the light-emitting elements of the first set are not emitting light, light output from the common optical element is within a second wavelength range, wherein the second wavelength range is different from the first wavelength range. Possibly, separate optical elements—for example a first optical element and a second optical element—could be provided for the first set of light-emitting elements and the second set of light-emitting elements, respectively, on the common carrier, such as described in the foregoing with reference to FIGS. 1 and 2.

As illustrated in FIG. 2, the first elongated carrier 2 may have a longitudinal axis L. Similarly, the second elongated carrier may have a longitudinal axis.

As illustrated in FIG. 1, the light-emitting elements 3 of the first set of light-emitting elements may be arranged in a plurality of successions, such as rows, lines or strings, on the first elongated carrier 2. For example, the light-emitting elements 3 of the first set of light-emitting elements may be arranged in three successions which are arranged adjacent to each other and each of which is parallel with the longitudinal axis L, as illustrated in FIG. 1. Each of the plurality of successions light-emitting elements 3 on the first elongated carrier 2 may be parallel to the longitudinal axis L of the first elongated carrier 2. Similarly, the light-emitting elements of the second set of light-emitting elements may be arranged in a plurality of successions, such as rows, lines or strings, on the second elongated carrier. For example, the light-emitting elements of the second set of light-emitting elements may be arranged in three successions which are arranged adjacent to each other and each of which is parallel with the longitudinal axis L, similarly to the light-emitting elements 3 of the first set of light-emitting elements on the first elongated carrier 2 which are illustrated in FIG. 1. Each of the plurality of successions light-emitting elements on the second elongated carrier may be parallel to the longitudinal axis of the second elongated carrier.

Possibly, all of the light-emitting elements in the respective ones of the plurality of successions of light-emitting elements on the first elongated carrier 2 and/or the second elongated carrier may be configured to emit light, when supplied with power, within a same wavelength range. In other words, all of the light-emitting elements in any succession of light-emitting elements, such as rows, lines or strings of light-emitting elements, may be configured to emit light of the same color.

However, the light-emitting elements in different ones of the plurality of successions of light-emitting elements on the first elongated carrier 2 and/or the second elongated carrier may be configured to emit light, when supplied with power, within different wavelength ranges. In other words, while all of the light-emitting elements in any succession of light-emitting elements, such as rows, lines or strings of light-emitting elements, may be configured to emit light of the same color, light-emitting elements in different successions may be configured to emit light of different color.

For example, with reference to the first elongated carrier 2 illustrated in FIGS. 1 and 2, the three successions of light-emitting elements of the first set of light-emitting elements arranged adjacent to each other and parallel to the longitudinal axis L may include light-emitting elements configured to emit red light, green light, and blue light, respectively, when supplied with power. In other words, all of the light-emitting elements in a first one of the three successions of light-emitting elements may be configured to emit red light when supplied with power, all of the light-emitting elements in a second one of the three successions of light-emitting elements may be configured to emit green light when supplied with power, and all of the light-emitting elements in the third one of the three successions of light-emitting elements may be configured to emit blue light when supplied with power. The lighting module 1 may for example be used in a filament lamp having a light-transmissive envelope at least in part enclosing the lighting module 1, with the lighting module being 1 arranged within the light-transmissive envelope. The light-transmissive envelope may for example comprise a clear bulb.

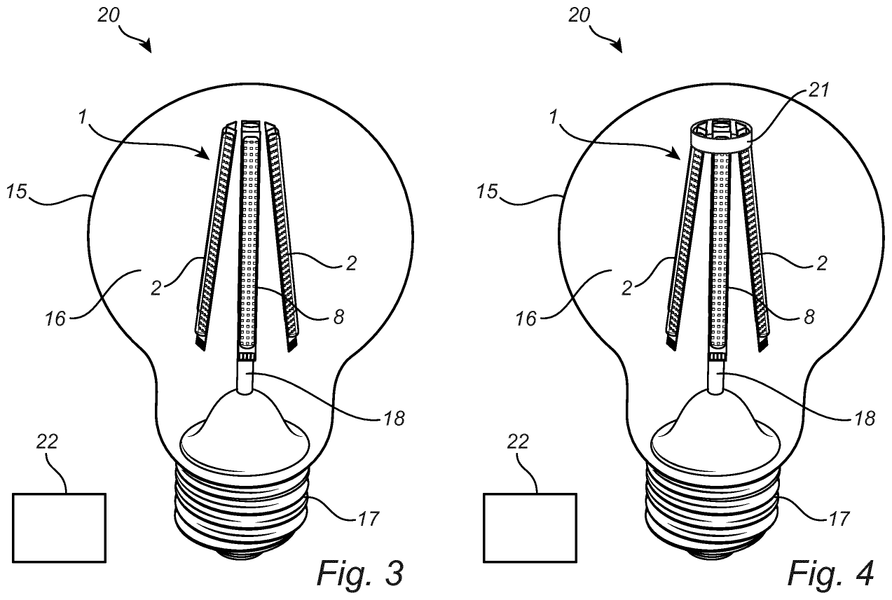

FIGS. 3 and 4 are views of lighting devices 20 according to embodiments of the present invention. Each of the lighting devices 20 comprises a lighting module 1 in accordance with an embodiment of the present invention.

Each of the lighting devices 20 comprises a light-transmissive envelope 15 which at least in part encloses the lighting module 1. The light-transmissive envelope 15 may at least in part define a fluidly sealed and enclosed space 16 within which the lighting module 1 is arranged, and which space 16 may include or be filled with air or a thermally conductive fluid, for example a gas including helium and/or hydrogen. Each of the lighting devices 20 may comprise a base 17 for connection to a lamp socket. The base 17 may include or be constituted by any suitable type of connector, for example an Edison screw base, a bayonet fitting, or another type of connection.

Each of the lighting devices 20 may for example be included in or constitute a LED bulb or retrofit lamp which is connectable to a lamp or luminaire socket by way of some appropriate connector, for example an Edison screw base, a bayonet fitting, or another type of connection suitable for the lamp or luminaire known in the art.

As known in the art, the lighting module 1 and/or the lighting device(s) 20 may include circuitry capable of converting electricity from a power supply to electricity suitable to operate or drive the light-emitting elements. The circuitry may be capable of at least converting between Alternating Current and Direct Current and converting voltage into a suitable voltage for operating or driving the light-emitting elements. The circuitry may for example be arranged at least in part within the base 17.

Each of the lighting modules 1 illustrated in FIGS. 3 and 4 comprises at least two first elongated carriers 2 (of which two are shown in FIGS. 3 and 4), each of which for example may be arranged or configured in accordance with the first elongated carrier 2 of the lighting module illustrated in FIGS. 1 and 2.

Further, each of the lighting modules 1 illustrated in FIGS. 3 and 4 comprises at least two second elongated carriers 8 (only one of which is shown in FIGS. 3 and 4), each of which for example may be arranged or configured in accordance with the second elongated carrier described in the foregoing with reference to FIGS. 1 and 2.

It is to be understood that each of the lighting modules 1 illustrated in FIGS. 3 and 4 in principle may comprise any number of first elongated carriers 2 and any number of second elongated carriers 8.

In accordance with the embodiments of the present invention illustrated in FIGS. 3 and 4, the first elongated carriers 2 and second elongated carriers 8 are arranged alternatingly about a longitudinal axis of the lighting device 20.

Each of the first elongated carriers 2 and second elongated carriers 8 of the lighting modules 1 illustrated in FIGS. 3 and 4 comprises a plurality of light-emitting elements supported on one side thereof, similarly to the first elongated carrier 2 illustrated in FIGS. 1 and 2 and the second elongated carrier described in the foregoing with reference to FIGS. 1 and 2.

As illustrated in FIGS. 3 and 4, there may be provided a support structure which supports the lighting module 1 in the lighting device 20. In accordance with the embodiment of the present invention illustrated in FIGS. 3 and 4, the support structure comprises a stem or cylindrical support 18 or the like connected to and/or supported by the base 17. The stem or cylindrical support 18 may extend for example along a longitudinal axis of the lighting device 20. There may be support rods or the like (not shown in FIGS. 3 and 4), possibly extending laterally from the stem or cylindrical support 18, and being coupled to each or any one of the lighting modules 1.

Compared to the lighting module 1 of the lighting device 20 illustrated in FIG. 3, the lighting module 1 of the lighting device 20 illustrated in FIG. 4 additionally comprises a coupling carrier 21. The coupling carrier 21 is configured to couple to and support each of the first elongated carriers 2 and the second elongated carriers 8. Each of the first elongated carriers 2 and the second elongated carriers 8 may be arranged to support a plurality of light-emitting elements. The coupling carrier 21 may have a first side that is contiguous to or congruous with the first side of each of the first elongated carriers 2 and the second elongated carriers 8. Further, the coupling carrier 21 may have a second side that is contiguous to or congruous with a second side of each of the first elongated carriers 2 and the second elongated carriers 8. The coupling carrier 21 may for example be rigid, and each or any of the first elongated carriers 2 and the second elongated carriers 8 may be flexible or rigid. The coupling carrier 21 may for example comprise a rigid PCB or another type of rigid support structure. Each or any of the first elongated carriers 2 and the second elongated carriers 8 may for example comprise a flexible PCB or a flexfoil or the like, or a rigid PCB or another type of rigid support structure.

At least some of the light-emitting elements of the lighting modules 1 illustrated in FIGS. 3 and 4, respectively, may be controllable with respect to operation thereof. Each or any of the lighting device 20 illustrated in FIGS. 3 and 4 may comprise a control unit, or controller, schematically indicated at 22, which control unit 22 may be connected with the communication element(s) and the light-emitting elements. The connection between the control unit 22 and the communication element(s) and the light-emitting elements, respectively, may be wired and/or wireless, for example employing wireless and/or wired communication techniques or means as known in the art. The control unit 22 may be configured to control operation of the at least some of the light-emitting elements. It is to be understood that the control unit 22 is drawn schematically. The control unit 22 could for example be arranged in the base 17 and/or within the space 16.

For example, the control unit 22 may be configured to control supply of power to at least some of the plurality of light-emitting elements. Supply of power to the plurality of light-emitting elements may be controllable individually or group-wise by the control unit 22.

With further reference to FIGS. 1 and 2, with respect to a first elongated carrier 2 and a second elongated carriers 8, which may support a first set of light-emitting elements and a second set of light-emitting elements, respectively, the control unit 22 may for example be configured to control supply of power selectively to the first set of light-emitting elements or to the second set of light-emitting elements, but not to both the first set of light-emitting elements and the second set of light-emitting elements at the same time.

In conclusion, a lighting module is disclosed, comprising at least one elongated carrier arranged to support a plurality of light-emitting elements and configured to provide power to the plurality of light-emitting elements. The plurality of light-emitting elements comprises at least a first set comprising a plurality of light-emitting elements and a second set comprising a plurality of light-emitting elements. The lighting module comprises at least one optical element coupled to the at least one elongated carrier and configured to receive light emitted from the first set of light-emitting elements when supplied with power and light emitted from the second set of light-emitting elements when supplied with power, respectively, mix the received light by means of diffusing and/or scattering the received light, and output the mixed light.

While the present invention has been illustrated in the appended drawings and the foregoing description, such illustration is to be considered illustrative or exemplifying and not restrictive; the present invention is not limited to the disclosed embodiments. Other variations to the disclosed embodiments can be understood and effected by those skilled in the art in practicing the claimed invention, from a study of the drawings, the disclosure, and the appended claims. In the appended claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. A lighting module comprising:
at least a first elongated carrier and a second elongated carrier, each arranged to support a plurality of light-emitting elements and configured to provide power to the plurality of light-emitting elements, the plurality of light-emitting elements comprising at least a first set of said plurality of light-emitting elements supported on the first elongated carrier and a second set of said a plurality of light-emitting elements supported on the second elongated carrier; and
at least a first optical element and a second optical element coupled to the at least first elongated carrier and to the at least second elongated carrier respectively, and said first and second optical elements being configured to receive light emitted from the first set of light-emitting elements when supplied with power and light emitted from the second set of light-emitting elements when supplied with power, respectively,
wherein the light-emitting elements of the first set and the second set and the at least first optical element and second optical element are configured such that, when the light-emitting elements of the first set are emitting light and the light-emitting elements of the second set are not emitting light, light output from the at least first optical element is within a first wavelength range, and such that, when the light-emitting elements of the second set are emitting light and the light-emitting elements of the first set are not emitting light, light output from the at least second optical element is within a second wavelength range, wherein the second wavelength range is different from the first wavelength range.

2. A lighting module according to claim 1, wherein the light-emitting elements of the first set and the second set and the at least first optical element and second optical element are configured such that, when the light-emitting elements of the first set are emitting light and the light-emitting elements of the second set are not emitting light, light output from the at least first optical element is white light, and such that, when the light-emitting elements of the second set are emitting light and the light-emitting elements of the first set are not emitting light, light output from the at least second optical element is colored light.

3. A lighting module according to claim 1, wherein each of the first elongated carrier and the second elongated carrier has a longitudinal axis, and wherein the light-emitting elements of the first set of light-emitting elements are arranged in at least one succession on the first elongated carrier parallel to the longitudinal axis of the first elongated carrier, and the light-emitting elements of the second set of light-emitting elements are arranged in at least one succession on the second elongated carrier parallel to the longitudinal axis of the second elongated carrier.

4. A lighting module according to claim 3,
wherein all of the light-emitting elements of the first set of light-emitting elements arranged in the at least one succession on the first elongated carrier are configured to emit light, when supplied with power, within the same wavelength range, or wherein at least one of the light-emitting elements of the first set of light-emitting elements arranged in the at least one succession on the first elongated carrier is configured to emit light, when supplied with power, within a different wavelength range than at least one other light-emitting element of the first set of light-emitting elements arranged in the at least one succession on the first elongated carrier; and/or
wherein all of the light-emitting elements of the second set of light-emitting elements arranged in the at least one succession on the second elongated carrier are configured to emit light, when supplied with power, within the same wavelength range, or wherein at least one of the light-emitting elements of the second set of light-emitting elements arranged in the at least one succession on the second elongated carrier is configured to emit light, when supplied with power, within a different wavelength range than at least one other light-emitting element of the second set of light-emitting elements arranged in the at least one succession on the second elongated carrier.

5. A lighting module according to claim 3, wherein the light-emitting elements of the first set of light-emitting elements are arranged in a plurality of successions on the first elongated carrier, each of the plurality of successions being parallel to the longitudinal axis of the first elongated carrier, and the light-emitting elements of the second set of light-emitting elements are arranged in a plurality of successions on the second elongated carrier, each of the plurality of successions being parallel to the longitudinal axis of the second elongated carrier.

6. A lighting module according to claim 5,
wherein all of the light-emitting elements in the respective ones of the plurality of successions of light-emitting elements on the first elongated carrier and/or the second elongated carrier are configured to emit light, when supplied with power, within a same wavelength range; and
wherein the light-emitting elements in different ones of the plurality of successions of light-emitting elements on the first elongated carrier and/or the second elongated carrier are configured to emit light, when supplied with power, within different wavelength ranges.

7. A lighting module according to claim 6, wherein the light-emitting elements of the first set of light-emitting elements are arranged in at least three successions on the first elongated carrier, each of the at least three successions being parallel to the longitudinal axis of the first elongated carrier, and/or the light-emitting elements of the second set of light-emitting elements are arranged in at least three successions on the second elongated carrier, each of the at least three successions being parallel to the longitudinal axis of the second elongated carrier;
wherein the light-emitting elements in different ones of the at least three successions of light-emitting elements on the first elongated carrier or the second elongated carrier are configured to emit red, green, and blue light, respectively, when supplied with power.

8. A lighting module according to claim 5,
wherein the plurality of successions of light-emitting elements on the first elongated carrier are staggered with respect to each other; and/or
wherein the plurality of successions of light-emitting elements on the second elongated carrier are staggered with respect to each other.

9. A lighting module according to claim 1, wherein the at least one optical element comprises at least one of: light scattering elements, luminescent material, or material configured to diffuse and/or scatter light incident or impinging thereon.

10. A lighting module according to claim 1, wherein the at least one optical element comprises a plurality of light diffusing layers which are optically interconnected with each other, wherein each of the plurality of light diffusing layers is configured to diffuse and/or scatter light incident or impinging thereon; or
wherein the at least one optical element comprises at least one light-transmissive layer and at least one light diffusing and/or scattering layer, wherein the at least one light-transmissive layer is configured to form a light mixing chamber for the received light capable of mixing the received light, and wherein the at least one light diffusing and/or scattering layer is configured to further mix the received light that has been mixed in the light mixing chamber by means of diffusing and/or scattering the light from the light mixing chamber.

11. A lighting module according to claim 1, wherein the lighting module comprises at least two elongated carriers, and wherein the lighting module further comprises a coupling carrier configured to couple to and support each of the at least two elongated carriers.

12. A lighting module according to claim 1, wherein the at least one elongated carrier is arranged to support the plurality of light-emitting elements at a first side of the at least one elongated carrier, wherein at least one electrical conductor for providing power to the plurality of light-emitting elements is arranged at a second side of the at least one elongated carrier.

13. A lighting device comprising:
a lighting module according to claim 1; and
a control unit connected to the at least one elongated carrier and configured to control supply of power to the plurality of light-emitting elements, wherein supply of power to the plurality of light-emitting elements can be controlled individually or group-wise by the control unit;
wherein the control unit is configured to control supply of power selectively to the first set of light-emitting elements or to the second set of light-emitting elements, but not to both the first set of light-emitting elements and the second set of light-emitting elements at the same time.
